(19) United States
(12) Patent Application Publication
(10) Pub. No.: US 2026/0340326 A1
(43) Pub. Date: Oct. 29, 2026

(54) Method and set-up assistant for the knowledge-based setting of operating parameters of a UHF RFID system

(71) Applicant: Balluff GmbH, Neuhausen a.d.F. (DE)

(72) Inventors: Albert Doneich, Ostfildern (DE); Thomas Graf, Blaubeuren (DE); Armin Failenschmid, Münsingen (DE); Christian Holder, Unterensingen (DE); Martin Kurz, Ebersbach/Fils (DE); Rainer Traub, Kornwestheim (DE); Stefan Kau, Bingen am Rhein (DE); Ingo Kleinschroth, Nürtingen (DE)

(73) Assignee: Balluff GmbH, Neuhausen a.d.F. (DE)

(21) Appl. No.: 19/566,795

(22) Filed: Mar. 13, 2026

(30) Foreign Application Priority Data
Apr. 24, 2025 (DE) 102025115705.7

(51) Int. Cl. G06K 7/10; G06N 3/045

(52) U.S. Cl. CPC G06K 7/10346; G06N 3/045

(57) ABSTRACT

In the computer-implemented method described here for the automatable setting of parameters of a UHF RFID system (100, 105, 300-315) for contactless data exchange between RFID transponders (125, 305-315) of objects (101) that are being moved past an RFID reader/writer (120, 200), wherein UHF antennas (102-104, 300) for contactlessly reading and/or writing to the RFID transponders (125, 305-315) arranged on these objects (101) are provided, provision is made, in particular, for a knowledge-based set-up assistant (400, 500) to be provided, by means of which settings for the parameters of the UHF RFID system that are suitable for an existing UHF RFID system not yet commissioned and for its intended use are determined on the basis of technical information.

### FIELD

The invention relates to the technical field of automatic recognition or identification of objects via radio by means of an RFID (radio frequency identification) system, in particular a UHF (ultra-high frequency) RFID system. Such an RFID system is known to allow contactless data exchange between an RFID transponder and an RFID writer or reader, UHF antennas being used for contactlessly reading and/or writing to RFID transponders (tags) arranged on such objects.

In this technical field, the invention relates to a method and a set-up assistant for the automatable setting or presetting of parameters of such a UHF-based RFID system.

### PRIOR ART

Using UHF technology in RFID systems allows a higher data transmission rate than when using just HF (high frequency) technology. As a result, faster transaction collection times and faster data processing are therefore possible, this being particularly advantageous in business and industrial environments.

UHF RFID technology is used, for example, in business applications such as inventory management, supply chain management, logistics, asset tracking and access control. This technology is typically used in applications requiring a long-read range.

Before operating an RFID system, the commissioning engineer must set operating parameters to achieve the expected or even optimal operation. The set-up of RFID systems can be divided into the following three categories: “Experience-based”, “Through simulation” and “Through measurements”. An example of a simulation-based solution is Turck's “Raytracer” software for the field simulation of complex UHF RFID applications which enables improved estimation of the reachability of “data carriers”, that is to say the RFID transponders or tags in question here. An example of an experience-based solution is an RFID assistant developed by Siemens as part of what is referred to as a “TIA portal” (totally integrated automation portal) which provides basic settings for communication with higher-level authorities.

### DISCLOSURE OF THE INVENTION

The technical problem underlying the invention is that many influencing factors, such as the configuration, the operational environmental conditions, the choice of antenna, etc., have to be taken into account when setting up and commissioning a UHF-based RFID system.

However, existing set-up and commissioning solutions always require decisions or assessments to be made by a UHF RFID system commissioning engineer. Since the commissioning engineers are not usually UHF specialists, unsuitable or even incorrect settings are often chosen. In particular, taking into consideration a certain reserve for minor deviations or tolerances of the system or the system's operational environmental conditions is often neglected.

The invention aims as far as possible to minimize or avoid such incorrect settings caused by the commissioning engineer as a source of error, and to achieve expected or even optimal operation.

The object of the invention is therefore to allow automatable or automated set-up and commissioning of a UHF RFID system as easily as possible and with the lowest possible technical complexity. This should also be made possible for commissioning engineers with limited technical knowledge. In particular, the technical requirements for commissioning engineers, especially with regard to a changed or new use or purpose, should also be simplified or reduced as much as possible.

To achieve this object and solve the corresponding technical problem, a corresponding set-up assistant, preferably supported by artificial intelligence (AI), is proposed which takes into account all technical information known per se and available for a UHF RFID system to be commissioned. This information relates not only to the respective existing UHF RFID system, but also to the expected or existing operational and application-related environmental conditions in the respective use of the UHF RFID system.

It should be noted that the set-up/commissioning and corresponding presetting of a UHF RFID system requires a not inconsiderable amount of knowledge to be transferred by the respective commissioning engineer to turn respective application-specific knowledge into individual technical set-up values. To be able to transfer such knowledge, the commissioning engineer therefore requires considerable technical expertise regarding the respective use or purpose of the UHF RFID system.

Within the framework of a corresponding dialogue with the commissioning engineer, the set-up assistant proposed according to the invention can ask them questions to elicit answers from the commissioning engineer to first of all preferably fundamental technical questions, such as the number of existing RFID transponders (or tags or corresponding data carriers) and the speed of movement of the objects with an RFID transponder shown in FIG. 1 that are to be scanned on the conveyor belt shown therein. In addition, however, the results of UHF-based RFID measurements between, for example, RFID transponders of objects to be scanned shown in FIG. 1 and the RFID reader, whether guided by the set-up assistant or carried out by the set-up assistant itself, are also taken into account. Alternatively, the commissioning engineer can also carry out such measurements under the guidance of the set-up assistant.

During these UHF-based RFID measurements, the set-up assistant or commissioning engineer can carry out a power scan and/or a position scan to obtain accurate information about the position of the reader's antenna(s), the respective existing antenna type and/or the antenna cable length. Additionally, a real-time scan can be carried out to determine the reliability of a UHF RFID system in question here.

The aim of using an AI-supported set-up assistant is to allow the automatic setting of parameters of the UHF RFID system, preferably operating parameters. Based on the abovementioned dialogue with the commissioning engineer, the set-up assistant determines or identifies the optimal parameter setting(s) for the respective use of the UHF RFID system.

In addition, a feedback loop can be set up in the set-up assistant, the commissioning engineer having to assess after a test run how accurately and reliably the UHF RFID system is functioning. This allows the set-up assistant to potentially find even better or optimal settings through further iterations. Furthermore, a continuously self-learning algorithm therefore can be formed which continually improves over time and with increasing use in the field. The set-up assistant is based here on feedback from numerous customers/commissioning engineers who have found optimal settings depending on the given influencing parameters. The set-up assistant can then use this knowledge to determine and suggest optimal operating parameters of new set-ups.

In the method proposed here for the automatable or automated setting or presetting of parameters of such a UHF-based RFID system, the data input from the commissioning engineer (based on the abovementioned dialogue), which depends on the respective use or purpose of the UHF RFID system, is accordingly automatically converted into suitable settings data by means of a set-up assistant based on artificial intelligence (AI), generative artificial intelligence (GenAI) or another knowledge-based method. These settings data are then transmitted to the UHF RFID system for commissioning thereof.

According to a first aspect of the computer-implemented method according to the invention for the automatable setting of parameters of a UHF RFID system for contactless data exchange between RFID transponders of objects that have RFID transponders and are being moved past an RFID reader/writer, wherein at least one UHF antenna for contactlessly reading and/or writing to the RFID transponders (tags) arranged on these objects is provided, provision is in particular made for a set-up assistant supported by or based on artificial intelligence (AI) or another knowledge-based method, by means of which settings for the parameters of the UHF RFID system that are suitable for an existing UHF RFID system to be commissioned and for its intended use are determined on the basis of technical information.

According to a further aspect of the method according to the invention, provision may be made for expected operating conditions to be derived by reference to the intended use of the UHF RFID system.

According to a further aspect of the method according to the invention, provision may be made for suitable parameters of the UHF RFID system to be determined by reference to a dialogue conducted between the set-up assistant and a commissioning engineer, wherein the set-up assistant is provided with the technical information on the UHF RFID system to be commissioned.

According to a further aspect of the method according to the invention, provision may be made for the technical information provided to the set-up assistant to relate to the number of existing RFID transponders and/or the possible positions of the RFID transponders and/or the speed of movement of the objects that have RFID transponders and are being moved past the RFID reader/writer. Provision may also be made here for the technical information provided to the set-up assistant to consist of the geometric arrangement (or a corresponding layout) of the RFID transponders or the corresponding tags or data carriers, antennas and the environment. Further information provided to the set-up assistant may be the electromagnetic environment of the RFID system. Of particular relevance here are metallic objects such as sheet metal, doors, machine parts, walls, steel beams and the like.

According to a further aspect of the method according to the invention, provision may be made for UHF-based RFID measurements to be carried out by the set-up assistant or by a commissioning engineer to obtain or determine the most accurate possible information about the position of the UHF antennas of the RFID reader/writer and/or the respective type of existing UHF antenna and/or the cable length of the UHF antennas and/or the electromagnetic environment of the UHF RFID system.

According to a further aspect of the method according to the invention, provision may be made for UHF-based RFID measurements to be carried out by the set-up assistant or by a commissioning engineer to obtain or determine information about the quality of the communication or of the contactless data exchange between the RFID reader/writer and the RFID transponders with variation in parameters and positions of the RFID transponders and the at least one UHF antenna.

According to a further aspect of the method according to the invention, provision may be made for the UHF-based RFID measurements to be carried out by reference to power scans and/or position scans and/or real-time scans.

According to a further aspect of the method according to the invention, provision may be made for the set-up assistant to carry out a test run on a UHF RFID system that has already been commissioned to assess how accurately and/or reliably the UHF RFID system is functioning, wherein the set-up assistant determines improved settings, depending on the results of the test run, by reference to further iterations.

According to a further aspect of the method according to the invention, provision may be made for the parameter settings of an already commissioned UHF RFID system to be continuously improved over time and with increasing use of the UHF RFID system by means of a self-learning AI algorithm.

According to a further aspect of the computer-implemented method according to the invention for the automatable set-up/commissioning of a UHF RFID system for a specified purpose, provision may be made for the method to be carried out by means of a set-up assistant having a large language model (LLM) and based on GenAI, wherein the method comprises the following steps:
Training a transformer-based set-up model by reference to operation-relevant data on the UHF RFID system or optimizing an existing transformer-based set-up model by reference to such data;
Providing, via a computer interface, the trained or optimized transformer-based set-up model which comprises at least one transformer component;
Communication by a commissioning engineer with the set-up assistant via the computer interface to collect data regarding the specified purpose of the UHF RFID system;
Prompting the trained, transformer-based set-up model to output optimized settings data using the collected data for the specified purpose;
Releasing the optimized settings data output by the trained transformer-based set-up model for the automatable setting or presetting of the UHF RFID system.

The abovementioned communication (or dialogue) between the commissioning engineer and the set-up assistant can take place in natural language or by reference to a specified list of questions, e.g. a multiple-choice list of questions, or also by reference to drawings.

The method according to the invention offers the commissioning engineer of a UHF RFID system increased benefits by enabling shorter set-up times, fewer sources of error during set-up and immediate operational readiness.

According to a further aspect of the method according to the invention, provision may be made for training the set-up model using deep learning and/or reinforcement learning technology. The use of these learning methods has the advantage over simple (or non-generative) machine learning approaches, which are best suited for clearly defined tasks with structured data, that they are also suitable for more complex tasks where the AI-based computer system has to process or semantically understand unstructured data. Deep learning imitates the workings of the human brain when processing data and establishing corresponding patterns, identifying patterns and relationships within a data set of human-generated content. By reference to patterns learned in this way, GenAI generates new content. A generative AI model is usually trained using a supervised learning approach. The abovementioned reinforcement learning technology mimics learning processes by which humans solve problems or achieve goals through trial and error.

The invention also relates to a computer-implemented method for the use of a trained, transformer-based set-up model as described above for generating settings data suitable for a specified purpose for the setting or presetting of a UHF RFID system, wherein the method comprises the following steps:
Providing access by a commissioning engineer to a trained, transformer-based set-up model by means of a computer processor;
Receiving input data relating to the specified purpose via a computer interface;
Prompting the trained, transformer-based set-up model to analyse the input data and provide instructions for the generation of new or amended settings data based on the trained set-up model.

According to a further aspect of this method according to the invention, provision may be made for the commissioning engineer to be prompted by means of a prompt to request the trained, transformer-based set-up model to provide machine-readable instructions on the basis of a request made to the set-up model by the commissioning engineer via the computer interface.

According to a further aspect of this method according to the invention, provision may be made for the prompt to comprise one or more operating instructions relating to one or more operating processes of the UHF RFID system according to the specified purpose. Provision may additionally be made here for the operating instructions to comprise machine-readable instructions for controlling and/or monitoring the operation of the UHF RFID system.

The invention also relates to a computer program product which comprises computer-readable instructions, which, when executed on a computer, prompt the computer to carry out the abovementioned method steps.

Furthermore, the invention relates to a computer product which comprises a computer-readable token for accessing training data used for the abovementioned training of a set-up model and/or for accessing an abovementioned trained or pre-trained set-up model.

The method implemented in the set-up assistant with regard to the respective purpose, that is to say the application-specific presetting or configuration of the UHF RFID system, allows the abovementioned settings data to be transferred as automatically as possible. The commissioning engineer, following an intuitively guided process, only needs to provide the knowledge about the respective use of an expert system underlying the set-up assistant.

The commissioning engineer therefore only needs to focus exclusively on the respective use or the respective purpose of the UHF RFID system and provide the corresponding input data. The set-up assistant or the underlying expert system asks fundamental questions guided hereby that are generally easy for the commissioning engineer to answer. This data input is automatically supplemented with expert knowledge about the use in the method according to the invention or the set-up and converted into technical settings data.

The method guides the commissioning engineer systematically and intuitively through specific dialogues, allowing them to contribute their knowledge of the technical situation of the respective use of the UHF RFID system. Due to the high degree of automation of the expert system, the user advantageously needs to make no or only very little effort to transfer knowledge.

The commissioning engineer therefore needs to focus exclusively on the set-up assistant and provide their input prompted by the set-up assistant. In particular, no transfer of knowledge or expertise on the part of the commissioning engineer is therefore required for the optimal setting or presetting of the UHF RFID system.

The uploading of technical settings data optimized for a specified purpose to a UHF RFID system in question here can then be carried out in a single process. This approach significantly improves the effectiveness and efficiency of the setting or presetting the UHF RFID system.

As a result, the set-up assistant proposed according to the invention or the underlying method for set-up/commissioning advantageously enables the automatable or automatic (pre) setting of suitable or even optimal operating parameters of a UHF RFID system in question here.

The set-up assistant can either be executed locally on an RFID device or set up as an online service. In particular, when using AI or another knowledge-based method, the assistant advantageously benefits from online experience gained from similar real-world uses of a UHF RFID system in question.

Furthermore, the set-up assistant proposed according to the invention or the method underlying the commissioning or set-up enables a commissioning engineer to easily operate corresponding RFID products.

### BRIEF DESCRIPTION OF THE DRAWINGS

Exemplary embodiments of the invention are shown in the drawings and are explained in more detail in the following description.

FIG. 1 shows the basic technical structure and a typical area of use of a UHF RFID system in question here according to the prior art.

FIG. 2 shows a simulation result of the propagation of UHF signals as viewed from a read/write head (source: www.turck.de/de/presse-135_simulationssoftware-fuer-uhfrfidapplikationen-1119.php) according to the prior art.

FIG. 3a shows a power curve know per se, captured using what is referred to as a “power scan”, between a UHF-based antenna and several objects to be scanned which have what are referred to as RFID “tags”.

FIG. 3b shows data obtained from what is referred to as a “position scan” to determine the optimal position of a UHF-based antenna relative to several objects having the abovementioned tags.

FIG. 3c shows the results of what is referred to as a “real-time scan” to determine the reliability of a UHF RFID system in question here.

FIG. 4 shows a schematic representation of the operation of a universal set-up assistant according to the invention.

FIG. 5 shows an exemplary embodiment of the method according to the invention for automatically setting the operating parameters of a UHF RFID system in question here by reference to a flowchart.

FIG. 6 shows an exemplary topology of a simple neural network for providing a set-up assistant according to the invention.

FIG. 7 shows the commissioning of a UHF RFID system shown in FIG. 1 by means of a set-up assistant according to the invention having a large language model and based on generative artificial intelligence for setting or presetting operating parameters of such a UHF-based RFID system, that is to say by reference to a combined flowchart/block diagram.

FIGS. 8A-8C illustrate the structure of a transformer encoder/decoder architecture in question here for generating operating parameter data, that is to say based on an abovementioned transformer-based commissioning or set-up model.

### EXEMPLARY EMBODIMENTS OF THE INVENTION

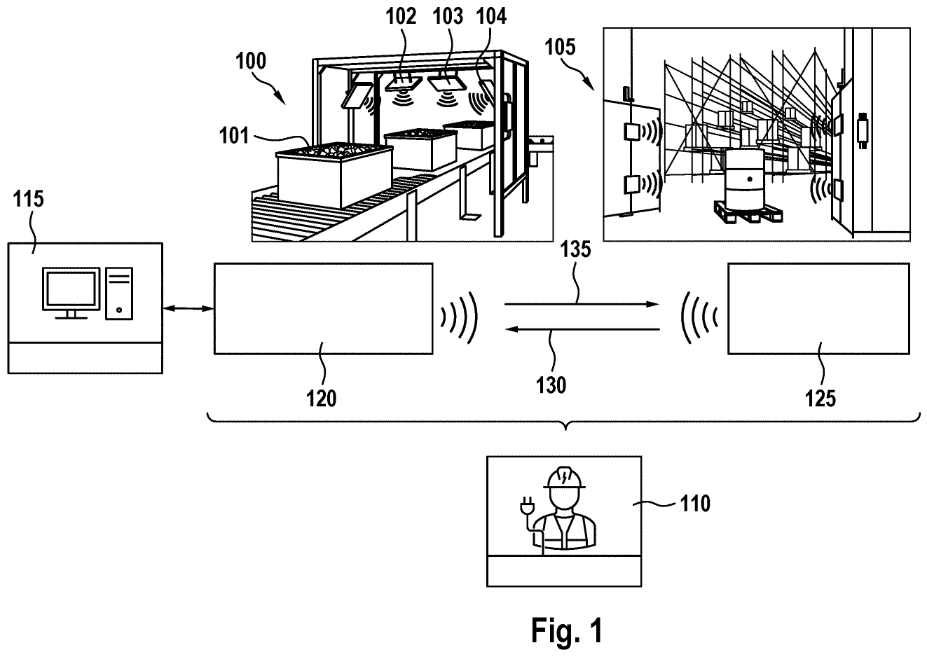

FIG. 1 shows the basic technical structure and two exemplary, typical areas of use of a UHF RFID system in question here. The areas of use shown are an inventory management system 100 for logistics of goods arriving on a conveyor belt and a goods receipt control system 105 provided at a goods entry gate.

An application 115 used by a commissioning engineer 110 of one of these systems 100, 105 interacts with an RFID reader/writer 120. The RFID reader/writer 120 (bidirectionally) exchanges data (135) wirelessly with a transponder (tag) 125 arranged on an (exemplary) object 101 transported in a container via UHF antennas 102, 103, 104 shown by way of example. In addition, the electrically passive transponder 125 is likewise wirelessly supplied with the necessary operating energy 130 by the RFID reader/writer 120 in a manner known per se.

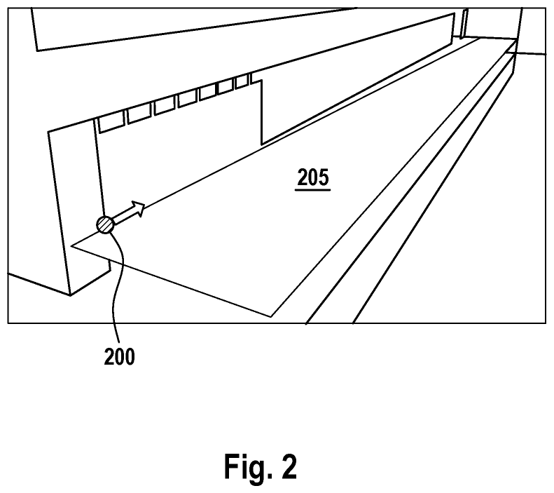

FIG. 2 illustrates the propagation behaviour 205 of the UHF signals emitted by a read/write head 200 by reference to simulation results generated in this exemplary embodiment using the Raytracer software from Hans Turck GmbH & Co. mentioned at the outset, specifically as viewed from the read/write head 200. According to the prior art mentioned at the outset, these enable the field simulation of complex UHF RFID applications for improved estimation of the spatial reachability of, for example, transponders in question here, for instance to avoid shadowing effects (see FIG. 1) or the like.

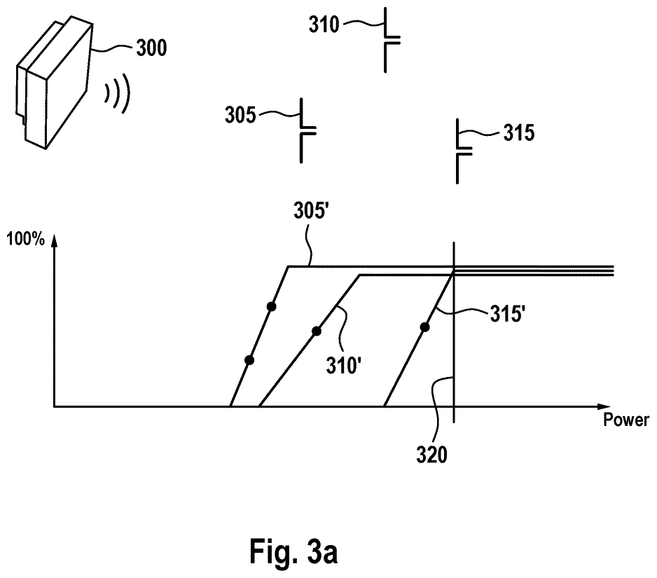

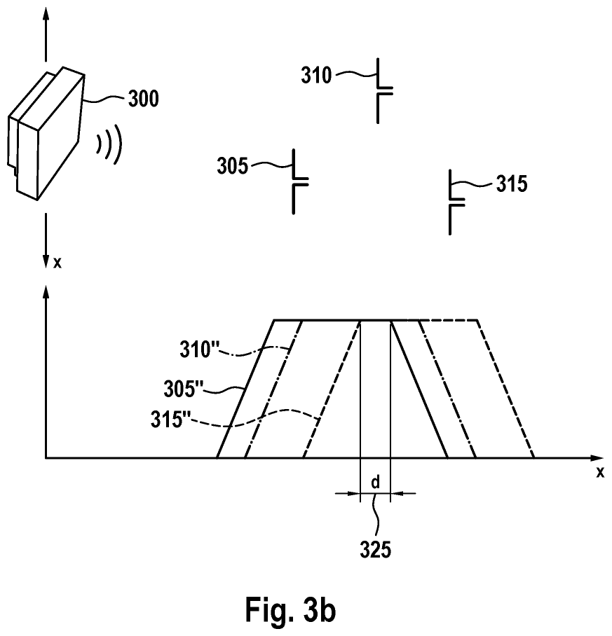

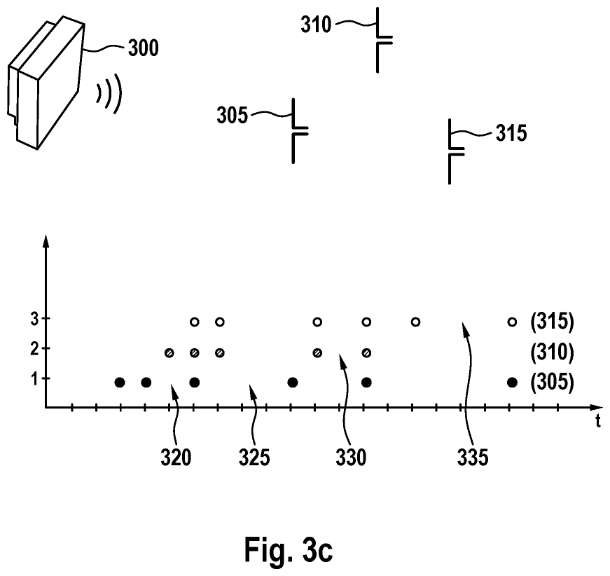

The following three measurements can be performed on the UHF RFID systems shown in FIGS. 3a-3c. For example, the objects shown by way of example in FIG. 1 (e.g. the object 101 explicitly shown therein) are provided with preferably passive RFID transponders 305, 310, 315 which are automatically read by the UHF antennas 102-104 shown therein or by the UHF antenna 300 shown by way of example in FIGS. 3a-3c.

The (electrically) passive RFID transponders (tags) 305-315 shown schematically therein each consist, in a manner known per se, of a microchip with a processor, an antenna and a permanent memory. Unlike active transponders, these tags do not have their own power supply, instead drawing their operating energy from the radio waves emitted by an RFID reader 120 equipped with a UHF antenna 300 (see FIG. 1). These transponders are available with either read-only memories or read-write EEPROM memories.

The passive transponders in question here are offered for various applications (i.e. different areas of use or purposes mentioned above) with different RFID chips, antennas and designs. Since the application area, including of the transponder mounting, significantly influences the transponder's performance, corresponding laboratory or on-site tests with original objects must be conducted before procuring RFID system components and the planned solution must be confirmed in a proof of concept (POC).

FIG. 3a plots the probability of a successful read/write process against the transmit power radiated by the UHF antenna 300 of the RFID reader 120. A probability value of 50%, for example, means that in a large number of attempts, the respective tag could be read in half of all cases. The three passive transponders (tags) 305, 310, 315 shown as examples are each known to have receiving antennas for the transmit power radiated by the UHF antenna 300 of the RFID reader 120.

In what are referred to as the experience-based “power scans” shown in FIG. 3a, a linear increase in the electrical energy or power radiated by the UHF antenna 300 results in the different slopes or curves 305′, 310′ and 315′ of the electrical energy radiated in each case by the three tags 305-315. According to the different distances existing between the respective tags 305-315 and the UHF antenna 300, the power required for operation is only achieved at a greater distance from the RFID reader 120 with a higher radiation power of the antenna of the RFID reader 120, that is to say, for example, with the tag 305 having a lower radiation power 305′ than with the tag 310 with the higher radiation power 310′. Accordingly, this power is achieved at the tag 315 with an even higher radiation power 315′.

FIG. 3b schematically shows the measurement results of the simulation of what is referred to as a “position scan” which serves to determine the suitable or optimal position of the UHF antenna 300 with respect to the three tags 305, 310 and 315. During this scan, the UHF antenna 300 is moved or displaced in the vertical x-direction shown, maintaining a distance in the existing horizontal direction from the three tags 305-315.

Based on the three curves 305″, 310″ and 315″ resulting from this scan representing the electrical power radiated at each of the three tags 305-315, sufficient reliability of the read/write operation of approximately 100% for all three tags 305-315 is achieved only in the relatively narrow or slender area ‘d’ 325 of the vertical direction of movement (x-direction) of the RFID reader 120 (see FIG. 3a).

As a result of the position scan, the RFID reader 120 should be arranged within the x-area ‘d’ in the vertical x-direction shown during a conveyor belt movement of the objects carrying the tags 305-315 (see FIG. 1) in the horizontal direction shown to ensure that all three passive transponders (tags) 305-315 are adequately supplied with energy as they pass the RFID reader 120.

FIG. 3c shows exemplary measurement results from what is referred to as a “real-time scan” by means of which the reliability of a UHF RFID system in question here can be determined. Reliability refers here in particular to the most reliable possible detection of objects (see FIG. 1) that are being moved past an RFID reader 120, each having tags 305, 310, 315.

In the scatter plot shown at the bottom in FIG. 3c, successful scan results of the existing three tags 305, 310, 315 are plotted as respective rows of dots over time ‘t’. The bottom row of dots ‘1’ here represents the scan results for the tag 305, the middle row of dots ‘2’ the scan results for the tag 310 and the top row of dots ‘3’ the scan results for the tag 315.

In this example scan, the tag 305 is detected six times by the UHF antenna 300, the tag 310 five times and the tag 315 likewise six times. According to the horizontally offset arrangement of the tags 305, 310 and 315 shown in FIG. 3c, the time diagram when passing the RFID reader 120 in a leftwards direction shows that the tag or the object with the tag 305 is detected first, followed by the tag 310, and then in turn the tag 315.

The existing limited reliability of the scan results or the recognition of passing tags, e.g. due to a less-than-optimal arrangement of the RFID reader 120, is evident from the fact that the three rows of dots ‘1’, ‘2’ and ‘3’ have some gaps in the (horizontal) time direction. By way of example, the gaps 320, 325, 330 and 335 are highlighted by arrows here.

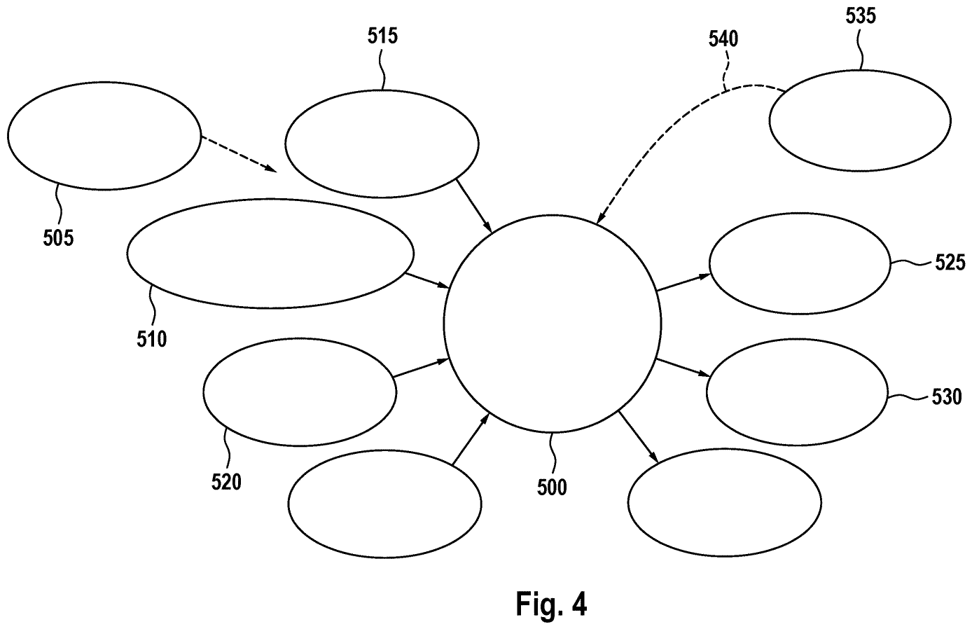

FIG. 4 illustrates exemplary method steps and corresponding interaction steps between a commissioning engineer and a set-up assistant 500 in question here.

The abovementioned interaction begins first of all with basic training 505 of the AI (e.g. GenAI) of the set-up assistant 500. During this training, the commissioning engineer performs a measurement 510 guided by the set-up assistant 500 by means of the described power scan, position scan and/or real-time scan. During this training, the commissioning engineer answers 515 questions posed by the set-up assistant 500 regarding the application, that is to the area of use or purpose, of the UHF RFID system to be set up.

It should be noted here that this dialogue between the commissioning engineer and the set-up assistant 500 can be carried out in natural language, through a predefined list of questions, e.g. multiple-choice questions, or by reference to drawings, the commissioning engineer providing 520 the set-up assistant 500, for example, with images or drawings of the application or of the corresponding UHF RFID system for the training thereof.

After basic training 505 has been completed, the set-up assistant 500 first of all outputs 525 a set of parameters which is suitable or even already regarded as optimal for the respective existing use of the RFID system. In addition, the set-up assistant 500 may also output 530 suggestions for improvement regarding the position of the antenna(s) of the UHF RFID system to be set up. These suggestions for improvement can then be additionally considered by the commissioning engineer for the final set-up of the UHF RFID system.

Finally, the commissioning engineer provides feedback 540 to the set-up assistant 500 regarding the technical requirements described for the reliability of the UHF RFID system set up, wherein the AI underlying the set-up assistant 500 can be retrained or further trained 535, if applicable, by reference to data measured during operation in order, as a result, to obtain a UHF RFID system that is as far as possible optimally set up or set for the respective existing technical application or respective existing purpose.

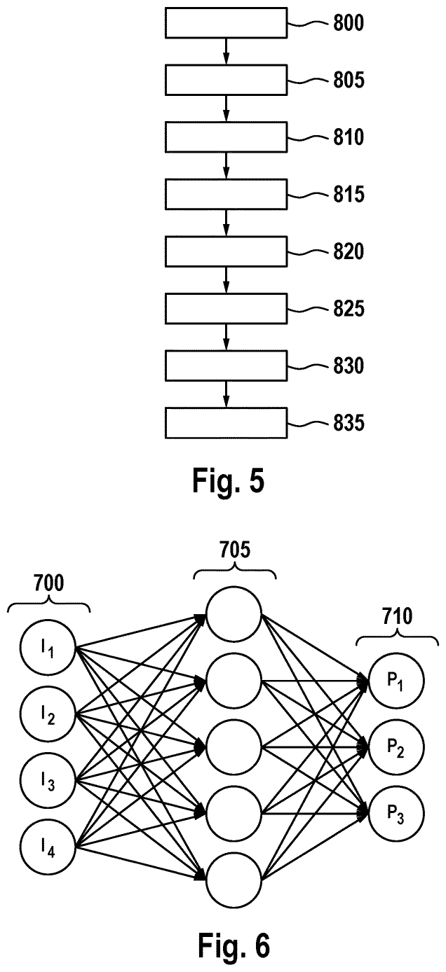

FIG. 5 illustrates a method according to the invention for the automatic setting of operating variables or operating parameters of a UHF RFID system in question here by reference to a flowchart. With reference to FIG. 1, the commissioning engineer interacts here with the set-up assistant.

In the first step of the method shown in FIG. 5, the installation takes place, with the commissioning engineer first of all setting up 800 the UHF RFID system with, for example, an empirically specified basic setting. In the second step 805, the set-up assistant asks the commissioning engineer simple questions. In the third step 810, the commissioning engineer answers the questions posed by the assistant. Afterwards, a guided measurement 815 is carried out, with the assistant guiding the commissioning engineer through a series of measurements. These measurements test the RFID system that has been set up in basic setting 800 to determine whether it delivers scan results that are actually usable for the application in question here or the existing purpose.

Based on the data obtained during the measurements 815, improved settings are now determined or specified 820 for the UHF RFID system, with the assistant calculating optimal settings based on the answers given by the commissioning engineer and the results of the guided measurement. Next, the RFID system is set 825, with the commissioning engineer implementing the optimal settings calculated by the assistant. Following this, an initially final test 830 of the RFID system set up in this way is performed (according to the abovementioned feedback loop), with the commissioning engineer using the RFID system to perform tests and providing corresponding feedback to the assistant. Finally, training 835 is provided in which the assistant is trained using the now existing data on the implemented settings.

The determination of suitable setting parameters by means of a data-driven GenAI-based optimization or learning approach described below 405 is carried out on the basis, for example, of the following model approach for the input variables of the set-up assistant:
Number of tags
Speed of the conveyor belt for the tags
Position of metallic objects in the environment, images and drawings (FIG. 4)
Results from measurements carried out:
   Proportion of successful communications with the tags in % depending on the position of the antennas manually adjusted by the commissioning engineer (position scan)
   Proportion of successful communications with the tags in % depending on the power adjusted by the RFID system (power scan)
   Time series of detected tags (result of the real-time scan)
   etc.

Parameters that the set-up assistant proposes or sets itself:
Transmit power of the antenna(s)
Number of antennas
Position of the antenna(s)
Filter parameters for evaluating the UHF messages of the tags
Modulation parameters of the antenna(s)
Polarization of the antenna(s)
etc.

The input variables and the parameters can be regarded as vectors land P (column vectors) with sizes n and m:

$$\vec{I} = [ \begin{matrix}{I}_{1} \\ {I}_{2} \\ ⋮\end{matrix} ] and \vec{P} = [ \begin{matrix}{P}_{1} \\ {P}_{2} \\ ⋮\end{matrix} ]$$

or Iⱼ with j=1 . . . n and Pᵢ=1 . . . m

The set-up assistant connects the parameters to the input variables via the multidimensional function f:

\vec{P}=ƒ(\vec{I})

According to the first exemplary embodiment, the relationship between input variables and parameters can be approximated by a linear function:

$${P}_{i} = {a}_{i} + {\sum }_{j}^{m} {B}_{ij} \cdot {I}_{j}$$

Higher-order terms can also be taken into consideration here:

$${P}_{i} = {a}_{i} + {\sum }_{j}^{n} {B}_{ij} \cdot {I}_{j} + {\sum }_{j}^{n} {\sum }_{k}^{n} {C}_{ijk} {I}_{j} \cdot {I}_{k} + …$$

wherein:
ai is a vector of size m (i=1 . . . m),
Bij is a matrix of size m×n (i=1 . . . m, j=1 . . . n) and
Cijk is a tensor of size m×n×n (i=1 . . . m, j=1 . . . n, k=1 . . . n).
   Regarding the data input/output for training an ML system in question here for an existing application or area of use, the use of vectors I and P can be regarded as a data model.
   In this data model, the abovementioned formulae P=f(I) are therefore used in method step 820 according to FIG. 5.

In the abovementioned method step 820, the optimal parameters P are determined on the basis of the input variables I collected in method steps 805, 810 and 815. This requires either the matrices Bij, Cijk, . . . or the look-up table or the weightings of the artificial neural network. In method step 825, the optimal parameters P determined in this way are then used to set the UHF RFID system. In the optional method step 830, a final test-that is to say in the form of a feedback loop-determines whether the abovementioned setting is actually optimal.

Since the set-up assistant is preferably operated as an (interactive) online service, the input variables I and the parameters P can be transmitted to the preferably cloud-based operator of the set-up assistant. In the cloud, with the aid of an AI-supported or knowledge-supported learning method, the matrices Bij, Cijk, . . . or the look-up table or the weightings of the artificial neural network can be learned or relearned from the newly transmitted and already existing experience data from similar real-world applications for training purposes (see step 835). The data obtained in this way for the matrices Bij, Cijk, . . . or the look-up table or the weightings of the artificial neural network can then be transferred to a plurality or multiplicity of set-up assistants arranged outside the cloud.

According to a second exemplary embodiment, a multidimensional look-up table can be used, the parameters being determined by interpolation between the two table values which correspond to the input parameters.

A third exemplary embodiment is the use of a neural network as a machine learning method: Here, the input values are used as node values for the input layer 700 of the neural network, and the node values of the output layer 710 are interpreted as parameters.

In FIG. 6, n=4 and m=3 and a single hidden layer 705 is chosen by way of example. The values of the nodes in a layer are determined as a weighted sum of all nodes in the adjacent layer to the left. In the training phase, the weightings are determined such that, for a large number of input values, the already known optimal parameters are ascertained as accurately as possible at the output layer and any error is minimized. If an unknown input vector is used in operation (also referred to as “inference”), then an optimal parameter vector is provided at the output layer.

If new optimal allocations between input variables and parameters come to light through feedback from commissioning engineers, these can be used to retrain or further train the neural network and thereby improve it.

In principle, other neural network topologies, such as a convolutional neural network, are also possible. A non-linear propagation function can also be used to calculate the nodes from left to right. In addition, other machine learning methods, such as random forest, are conceivable.

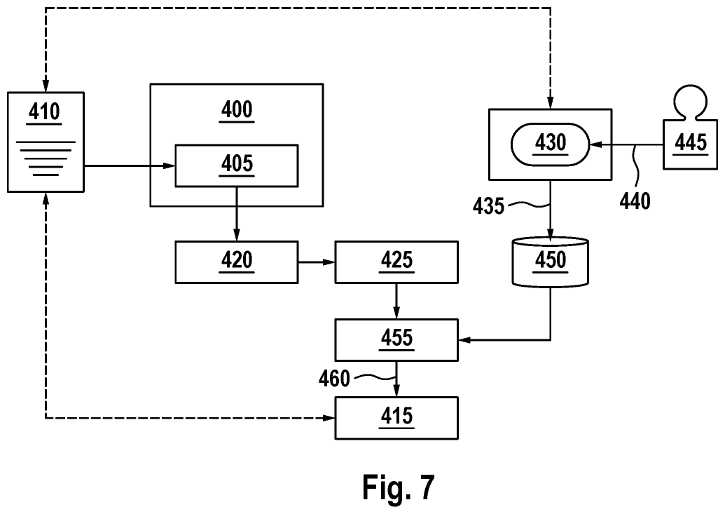

As a GenAI approach, for example, a GenAI system, described in greater detail below with reference to FIG. 7, using a neural network can be provided for the automatable or GenAI-supported (pre) setting of operating parameters of an underlying UHF RFID system.

The exemplary embodiment of method steps of a set-up assistant 400 according to the invention shown in FIG. 7 is based here on a GenAI-based optimization approach or corresponding learning approach 405, by means of which suitable settings or presettings are determined for a specified application scenario or purpose 410 of an area of use of a UHF RFID system, for example, as described by way of example in FIG. 1. Furthermore, corresponding operation-relevant and/or product-relevant data 425 are created in respect of the specified application scenario 410 by means of data preprocessing for the (pre-) settings data 420 thus determined.

The GenAI-based computer interface 430 serves in particular first of all to record and temporarily store as data the technical information and framework conditions 435 required for commissioning the UHF RFID system with regard to the intended purpose. The (pre) setting is carried out in particular with regard to the specifically existing application scenario or purpose 410, that is to say through interactions 440 conducted via a corresponding computer interface in natural language with a commissioning engineer 445 as a user of the set-up assistant 400.

The purpose is input via a corresponding prompt to the commissioning engineer, wherein the input comprises one or more contexts which refer to further technical information regarding the specified purpose. The contexts regarding the specified purpose can be processed in terms of data on the basis of associated context data/meta data.

By reference to the data 435 collected through the inputs 440 by the commissioning engineer 445, the set-up assistant 400 trains a specified transformer-based set-up model 450 existing in a database or in data storage for the respective existing UHF RFID system and the respective purpose. The set-up model 450 which has been pre-trained in this way and has or comprises at least one transformer component described below is provided to the commissioning engineer 445 for interaction 440 via the computer interface 430.

The existing set-up model 450 is retrained using second training data generated on the basis of an updated settings data set. The transformer-based set-up model retrained in this way is now released to the respective commissioning engineer 445 via the computer interface 430 for the automatable (pre) setting of the existing UHF RFID system 415 and the respective existing purpose.

The set-up model trained in this way can now be used to generate a (pre) settings data set suitable for a now existing purpose for the operation of an existing UHF RFID system 415. Use is carried out through interaction of a commissioning engineer 445 by means of the set-up assistant 400 which is based on or works in conjunction with the GenAI system. The commissioning engineer 445 accesses the respective existing trained, transformer-based set-up model by means of a computer processor. Input data relating to the specified purpose are collected via the computer interface 430. The now existing, current set-up model 450 is now prompted to analyse the input data and provide instructions 460 for generating a new or modified (pre) settings data set 455 based on the current set-up model.

The UHF RFID system 415 can now be automatically configured for the specified purpose by reference to the generated new or modified (pre) settings data set 455. For this purpose, a suitable prompt can be used to request the set-up model to provide machine-readable instructions based on a request made to the set-up model by the commissioning engineer via the computer interface.

The prompt may comprise one or more operating instructions relating to one or more operating processes of the UHF RFID system 415 according to the purpose. The operating instructions may comprise machine-readable instructions for controlling and/or monitoring the operation of the UHF RFID system 415.

The commissioning engineer 445 advantageously does not have to deal with the individual technical parameters and their significance, as is common in the current prior art. A configuration with individual (pre) setting values, as practised in the prior art, is therefore not required.

The method described for the automatable commissioning or corresponding (pre) setting of a UHF RFID system 415 in question here also significantly reduces the effectiveness and efficiency of commissioning, particularly of more complex UHF RFID systems.

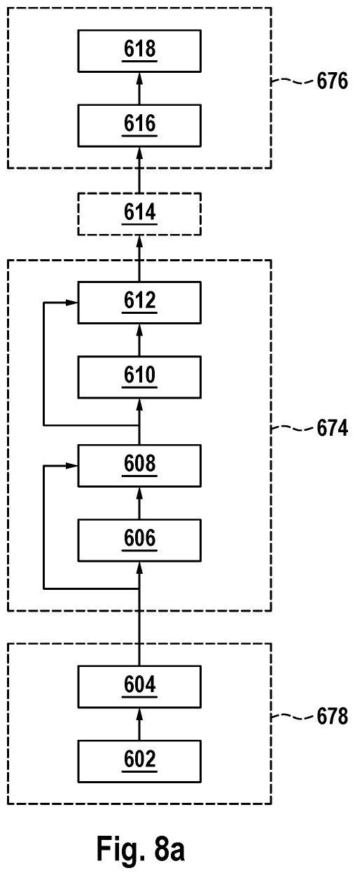

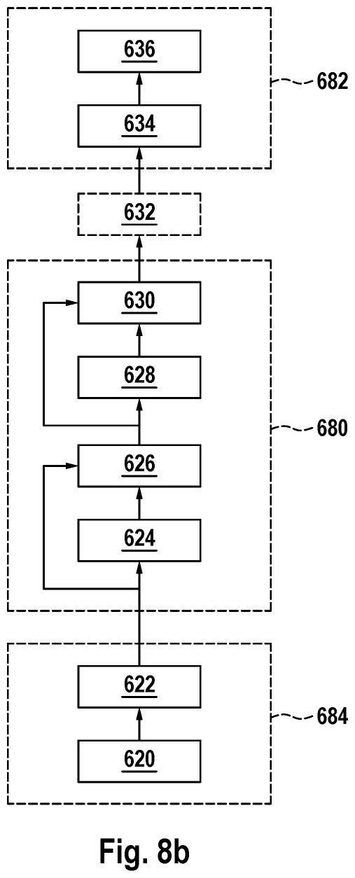

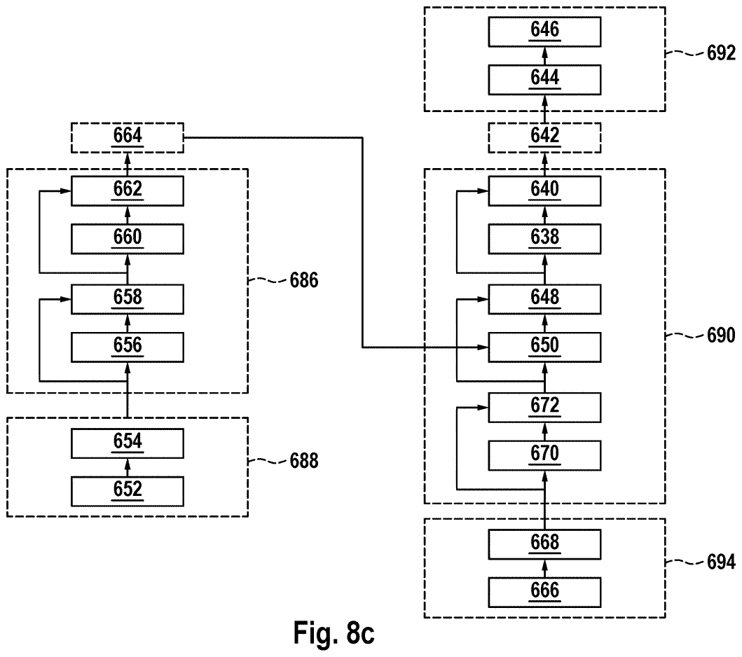

FIGS. 8a-8c illustrate the structure known per se of a transformer encoder/decoder architecture in question here for generating parameter data based on the abovementioned transformer-based set-up model.

FIG. 8a illustrates an embodiment of a transformer encoder architecture. The transformer encoder comprises an encoder input 678, one or more encoder blocks 674, 614 and an encoder output 676. In the exemplary embodiment, the encoder output 676 comprises two processing levels, namely a linear layer 616 and what is referred to as a “softmax” layer 618. Such a linear layer is known to be used to connect every input neuron to every output neuron of the neural network. Such a softmax layer is known to be commonly used in the final layer of a neural network model for classification tasks and converts raw output values (what are referred to as “logits”) into probabilities by forming the exponential function of each output and normalizing these values by dividing by the sum of all values. This allows a vector of K real values to be transformed into a vector of K real values whose sum equals 1. The input values may can be positive, negative, zero or greater than one, the softmax function transforming them into values between 0 and 1 so that these values can be interpreted as probability values.

The transformer encoder architecture shown here can be derived from the transformer encoder-decoder architecture known in the prior art (see FIG. 8c). The transformer encoder architecture shown may have an additional encoder output to connect the encoder block directly to the decoder of a transformer encoder-decoder architecture, as shown in FIG. 8c.

The input data are received at the encoder input 678 which can apply what is referred to as “embedding” 602 to the input data. Applying input embedding 602 may refer to passing the input data on through an embedding layer. The encoder input 678 may also apply position encoding 604. Applying position encoding 604 may refer to adding a position factor to the embedded input data. The input data can preferably specify a sequence of elements, wherein the position factor can provide an indication of the position of the elements within the sequence.

The embedded input data can be processed by one of the encoder blocks 674, 614 (optional block) shown. The embedded input data can be provided to a normalization 608 carried out for the respective levels or layers of the underlying software architecture (referred to hereinbelow as “layer normalization”) via a special data connection. Such levels/layers relate, for example, to the use level (or user interface), the level of the large language model and a data level intended for training a set-up model here.

For the input data embedded in this way, what is referred to as a “multi-head self-attention” mechanism 606 can be implemented, this allowing an underlying model to focus on different parts of the input data, similar to how people pay attention to specific words when understanding a sentence. This mechanism allows the model to decide which parts of the input are relevant for a given task, making it extremely flexible and powerful. Such a process step involving transformers is thus used to improve the expressiveness and modelling capabilities of the neural network underlying the AI system. This allows transformers to capture various types of dependencies and relationships between words or elements in a sequence of input data. Such a process step can also be understood as a filter applied to the embedded input data. By applying the filter to the embedded input data, the elements associated with the embedded input data which contribute to the output data to be generated can be identified for the generation of the output data. The filter can therefore represent the degree of contribution of the elements associated with the embedded input data to the output data to be generated.

For the embedded input data, in addition to the multi-head self-attention 606, what is referred to as a “feed-forward” layer 610 and a corresponding layer normalization 612 can be provided. By means of such feed-forward layers, a forwards-directed neural network is formed in a manner known per se which consists of an input level, one or more hidden levels and an output level. The data thus flow only in one direction, that is to say from the input layer through the hidden layers to the output layer.

FIG. 8b illustrates an embodiment of a transformer decoder architecture. The transformer decoder comprises a decoder input 684, one or more decoder blocks 680, 632 and a decoder output 682. In the exemplary embodiment, the decoder output 682 likewise comprises two processing levels, that is to say a linear layer 634 and what is referred to as a “softmax” layer 636. The existing transformer decoder architecture can be derived from the transformer encoder-decoder architecture known in the prior art and shown in FIG. 8c. The transformer decoder architecture can correspond to that decoder architecture associated with the transformer encoder-decoder architecture, that is to say irrespective of whether the encoder of the transformer encoder-decoder obtains one or more hidden states. Numerous such transformer decoder architectures are available in the prior art, for example the generalized and already trained “GPT” transformers known per se.

The decoder input 684 can apply the input data embedding 620 existing here and position encoding 622 analogously to the input embedding 602 and position encoding 604 as described in the corresponding context of FIG. 8a. The decoder block 680 may comprise the corresponding layer normalizations 626, a masked multi-head self-attention 624, what is referred to as a “feed-forward” layer 628 and a corresponding layer normalization 630, which are provided via a special data connection to the respective layer normalization 626.

The masked multi-head self-attention 624 can also be applied to the embedded input data, the masked multi-head self-attention 624 essentially corresponding to that in the context of FIG. 8a. However, it includes additional masking of a portion of the embedded input data which are associated with elements that appear later in the sequence than the element to be generated.

Additionally or alternatively, the portion of the input data associated with elements that appear later in the sequence than the element to be generated may possibly not be obtained or received and/or may possibly not be converted into the embedded input data. The transformer encoder can therefore be configured for classification tasks, whilst the transformer decoder can only be configured for text generation.

FIG. 8c illustrates the interplay or interaction between a described transformer encoder and a transformer decoder.

The transformer encoder-decoder can comprise the encoder input 688, the one or more encoder blocks 686, 664, the decoder input 694, the decoder block 690 and the decoder output 692. In the exemplary embodiment, the decoder output 692 likewise comprises two processing levels, that is to say a linear layer 644 and what is referred to as a “softmax” layer 646. The encoder input 688 can correspond to the encoder input 678 in FIG. 8a. The one or more encoder blocks 686, 664 may correspond to the one or more encoder blocks 674, 614 from FIG. 8a. The decoder input 694 may correspond to the decoder input 684 of FIG. 8b. The decoder block 690 may have a masked multi-head self-attention 670, a layer normalization 672, an already mentioned feed-forward layer 638 and a layer normalization 640. These can be configured analogously to the masked multi-head self-attention 624, the layer normalization 626, 630 and the feed-forward layer 628, as described in the context of FIG. 8b. The decoder block 690 can further comprise a multi-head self-attention 650 and a layer normalization 648.

Analogously to the description of FIG. 8b, the context tensor may be obtained from the masked multi-head self-attention 670 and the layer normalization 672. The layer normalization 648 can be applied to the context vector obtained from the multi-head self-attention 650 and the hidden states of the one or more encoder blocks 686, 664. The context vector resulting from the layer normalization 648 can be processed, analogously to the description of FIG. 8b, via a feed-forward level or layer 638 by means of an abovementioned layer normalization 640.

The context vector resulting from the layer normalization 640 can be provided to further decoder blocks 642 analogously to the decoder block 690. The context vector obtained from the one or more decoder blocks 690, 642 can be provided to the decoder output 692. The decoder output 292 may correspond to the decoder output 682 of FIG. 8b.

With the architecture described, the transformer encoder-decoder can obtain or receive input data at the encoder input 688 and the one or more encoder blocks 686, 664 as well as the decoder block 690 and the decoder output 692 and process them as described. Based on the input data, the transformer encoder-decoder can sequentially generate output data. The output data sequentially generated in this way can be provided to and/or processed by the decoder input 694, the one or more decoder blocks 690, 642 and the decoder output 692.

A sequence can preferably be provided to the encoder input 688. After generating at least a portion of the output data, the decoder input 694 can in turn be supplied with at least a portion of the elements of the already generated output data. This allows the next elements of the output data to be generated with higher accuracy by taking into account both the input data and the generated output data.

1. Computer-implemented method for the automatable setting of parameters of a UHF RFID system (100, 105, 300-315) for contactless data exchange between RFID transponders (125, 305-315) of objects (101) that have RFID transponders and are being moved past an RFID reader/writer (120, 200), wherein at least one UHF antenna (102-104, 300) for contactlessly reading and/or writing to the RFID transponders (125, 305-315) arranged on these objects (101) is provided, characterized in that a knowledge-based set-up assistant (400, 500) is provided, by means of which settings for the parameters of the UHF RFID system (100, 105, 300-315) that are suitable for an existing UHF RFID system (100, 105, 300-315) to be commissioned and for its intended use are determined on the basis of technical information.

2. Method according to claim 1, characterized in that the knowledge-based set-up assistant (400, 500) is supported by or based on artificial intelligence (AI) or empirical knowledge.

3. Method according to claim 1, characterized in that expected operating conditions are derived by reference to the intended use of the UHF RFID system (100, 105, 300-315).

4. Method according to claim 1, characterized in that suitable parameters of the UHF RFID system (100, 105, 300-315) are determined by reference to a dialogue conducted between the set-up assistant (400, 500) and a commissioning engineer (110, 445), wherein the set-up assistant (400, 500) is provided with the technical information on the UHF RFID system (100, 105, 300-315) to be commissioned.

5. Method according to claim 4, characterized in that the technical information provided to the set-up assistant (400, 500) relates to the number of existing RFID transponders (125, 305-315) and/or the possible positions of the RFID transponders (125, 305-315) and/or the speed of movement of the objects (101) that have RFID transponders and are being moved past the RFID reader/writer (120, 200) and/or the number and/or the type and/or the position and/or the cable lengths of the at least one UHF antenna (102-104, 300) and/or the electromagnetic environment of the UHF RFID system (100, 105, 300-315).

6. Method according to claim 1, characterized in that UHF-based RFID measurements are carried out by the set-up assistant (400, 500) or by a commissioning engineer (110, 445) to obtain or determine information about the quality of the communication or of the contactless data exchange between the RFID reader/writer (120, 200) and the RFID transponders (125, 305-315) with variation in parameters and positions of the RFID transponders (125, 305-315) and the at least one UHF antenna (102-104, 300).

7. Method according to claim 6, characterized in that the UHF-based RFID measurements are carried out by reference to power scans and/or position scans and/or real-time scans.

8. Method according to claim 1, characterized in that the set-up assistant (400, 500) carries out a test run on a UHF RFID system (100, 105, 300-315) that has already been commissioned to assess how accurately and/or reliably the UHF RFID system (100, 105, 300-315) is functioning, wherein the set-up assistant (400, 500) determines improved settings, depending on the results of the test run, by reference to further iterations.

9. Method according to claim 1, characterized in that the parameter settings of an already commissioned UHF RFID system (100, 105, 300-315) are continuously improved over time and with increasing use of the UHF RFID system (100, 105, 300-315) by means of a self-learning AI algorithm.

10. Method according to claim 1, characterized in that the method is carried out by means of a set-up assistant (400, 500) having a large language model (LLM) and based on GenAI (405), wherein the method comprises the following steps:
Training (505, 535) a transformer-based set-up model by reference to operation-relevant data (425) on the UHF RFID system (100, 105, 300-315) or optimizing an existing transformer-based set-up model by reference to such data;
Providing, via a computer interface, the trained or optimized transformer-based set-up model which comprises at least one transformer component;
Communication (515, 520) by a commissioning engineer (110, 445) with the set-up assistant (400, 500) via the computer interface to collect data regarding the specified purpose of the UHF RFID system (100, 105, 300-315);
Prompting (525) the trained, transformer-based set-up model to output optimized settings data using the collected data for the specified purpose;
Releasing the optimized settings data output by the trained, transformer-based set-up model for the automatable setting or presetting of the UHF RFID system (100, 105, 300-315).

11. Method according to claim 10, characterized in that the training (505, 535) of the set-up model is carried out using deep-learning and/or reinforcement-learning technology.

12. Method according to claim 10, characterized in that a commissioning engineer (110, 445) is prompted by means of a prompt to request the trained, transformer-based set-up model to provide machine-readable instructions on the basis of a request made to the set-up model by the commissioning engineer (110, 445) via the computer interface.

13. Method according to one or more of claim 10, characterized in that the prompt comprises one or more operating instructions relating to one or more operating processes of the UHF RFID system (100, 105, 300-315) according to the specified purpose. Provision may additionally be made here for the operating instructions to comprise machine-readable instructions for controlling and/or monitoring the operation of the UHF RFID system (100, 105, 300-315).

14. Use of a trained, transformer-based set-up model for generating settings data suitable for a specified purpose for the setting of a UHF RFID system (100, 105, 300-315), characterized by the following steps:
Providing access by a commissioning engineer (110, 445) to a trained, transformer-based set-up model by means of a computer processor;
Receiving (515, 520) input data relating to the specified purpose via a computer interface;
Prompting (525) the trained, transformer-based set-up model to analyse the input data and provide instructions for the generation of new or amended settings data based on the trained set-up model.

15. Set-up assistant (400, 500) for the automatable setting of parameters of a UHF RFID system (100, 105, 300-315) for contactless data exchange between RFID transponders (125, 305-315) of objects (101) that have RFID transponders and are being moved past an RFID reader/writer (120, 200), wherein UHF antennas (102-104, 300) for contactlessly reading and/or writing to the RFID transponders (125, 305-315) arranged on these objects (101) are provided, characterized in that, according to the method set out in one or more of the preceding claims, suitable settings for the parameters of the UHF RFID system (100, 105, 300-315) are determined by means of empirical knowledge or by means of artificial intelligence (AI) on the basis of technical information in respect of an existing UHF RFID system (100, 105, 300-315) to be commissioned and its intended use.

16. Set-up assistant (400, 500) according to claim 15, characterized in that expected operating conditions of the UHF RFID system (100, 105, 300-315) are derived by means of artificial intelligence by reference to the intended use of the UHF RFID system (100, 105, 300-315).
